(19) United States
(12) Patent Application Publication
(10) Pub. No.: US 2006/0095845 A1
(43) Pub. Date: May 4, 2006

(54) Method and apparatus for presenting a list of items

(75) Inventor: Marco Van Leeuwen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/538,607

(22) PCT Filed: Nov. 5, 2003
(86) PCT No.: PCT/IB03/05011

§ 371 Date: Jun. 10, 2005

(30) Foreign Application Priority Data
Dec. 11, 2002 (EP) 02080246.8

(51) Int. Cl. G06F 3/00

(52) U.S. Cl. 715/700

(57) ABSTRACT

A method and an apparatus for presenting a long list of items are described. An apparatus (1) is designed to display one page of items and a set of browse control tools (40) which include page indicators, the apparatus having user input means (4). The apparatus is designed to display a new page in response to user input commands. The apparatus is further designed to set a step length, i.e. the distance (number of items) between current page and new page, in response to user input commands. The browse control tools (40) comprise a plurality of hierarchic volumes (41, 42, . . . 45), each volume comprising a plurality of page indicators (51, 52, . . . 45).

The present invention relates in general to a method for presenting a long list of many items to a user. Although other applications are feasible, the present invention relates particularly to presenting a long list of many items on a display screen of a user appliance, such as for instance a mobile telephone, a lap top or desktop PC, a personal digital assistant (PDA), a television, etc, and the present invention will hereinafter be explained in more detail with a view to such an application, but this should not be interpreted as limiting the scope of the invention.

For practising the present invention, the type of item is not important. For instance, the item may be a picture, or a piece of text, or a combination of a picture plus text. The user may be interested in the items themselves, or in some other entity represented by the item. This will be explained in the following examples.

The user may have a collection of photos, for instance digital photos, stored on a computer-accessible memory such as a hard disc, an optical disc, etc. Each photo may be represented by a picture showing the photo in the actual size or on scale. The picture may be accompanied by some text regarding the subject of the photo, such as date, place, etc.

The user may have a collection of image scenes, i.e. portions of a movie or film, for instance recorded by a camcorder. All the image scenes may be taken from one and the same production. Each scene may be represented by a picture showing a still image taken from such a scene, and/or a piece of text describing the scene.

The user may have a collection of audio tracks, for instance MP3 tracks. Each track may be represented by a piece of text, such as a title, possibly accompanied by a short description of, for instance, performer, duration, type of instrument, etc.

The user may have a collection of documents, for instance patent documents obtained as result of a prior-art search. Each document may be represented by a piece of text, for instance comprising title, number, date of publication, summary, possibly accompanied by a picture, for instance the main drawing. The user's interest may be taken to the summaries only, but it may also be that the user is actually interested in the full text document if the summary meets his search requirements.

In another example, the documents are text documents stored in a computer memory without structuring the storage into folders. These documents may be, for instance, letters written by the user, or emails received by the user, etc. Each document may be represented by a piece of text, for instance comprising a name, a date, etc. The text documents may also be a simple description of address and telephone number of a person, in which case each document may be represented by the person's name.

In each of the above examples, an item is in fact a representation of an actual entity (photo, image scene, audio track, document, respectively) in which the user is interested. In the following description, selecting an item will be considered as being equivalent to selecting the entity. Also, the wording “item” and “entity” may be used in an inter-exchangeable way, if the distinction is not important in the context.

However, the entities and items may, in fact be identical. A text document may be considered as constituting a collection of lines. When part of the text document is displayed on a screen, this can be considered as constituting a list of items, each identical to an entity (line).

The entities in the collection may be arranged according to some characteristic meaningful to the user. For instance, in the case of addresses and telephone numbers of people, the entities may be arranged alphabetically according to person's names. In the case of photos, the entities may be arranged according to day of shooting. Normally, in a list of items, the items will be arranged accordingly. The list may also be arranged according to some user-selectable characteristic. However, the arrangement may also be random, or at least not particularly useful to the user, such as in the case of prior-art search results.

In practice, it may happen that a user wishes to access a collection of items, for whatever purpose. Particularly, the user may wish to select one specific item of the collection, for instance one photo, for processing such as printing. Or, the user may wish to select one specific image scene for processing such as making his own movie. Or, the user may wish to select one specific document, for printing and/or reading. He may be looking for one specific item, for instance one photo he remembers. He may also wonder whether a certain item is present in the collection, for instance a publication anticipating his patent application. He may also just wish to read a long document. In all of these cases, the user needs to browse through the collection.

The present invention specifically aims at facilitating such browsing.

Conventionally, items are presented to the user in the form of a sub-list, which will hereinafter be indicated by the phrase “page”, displayed on a screen of a user appliance, such as for instance a computer monitor. Typically, the items are arranged one below the other. The number of items presented to the user at one time corresponds to the number of items fitting on the screen. Browsing typically includes scrolling and paging. In the context of the present invention, the phrase “scrolling” will be used to indicate that one item is taken from the page and one new item is added to the page (for instance: all items shift one position upwards, the topmost item disappears and a new item is introduced at the bottom). Furthermore, the phrase “paging” will be used to indicate that the display shifts one page up or down. These actions may be performed for instance by pressing the well-known PAGE-UP and PAGE-DOWN keys of a computer keyboard, or suitable mouse-clicks in appropriate locations on the screen.

One problem associated with browsing by scrolling or paging is that, in the case of a relatively large number of items, browsing takes a lot of time and requires many user actions (key strokes, mouse clicks). It is one objective of the present invention to facilitate browsing so that a user may reach a target item more quickly and with a reduced number of actions.

Another conventional problem is that the user is not offered a good sense of location, i.e. relative position of the current page within the list. In well-known computer programs for text processing, such as for instance Microsoft Word, a scroll-bar or slider is imaged on the screen, where the position of an icon on the scroll-bar represents the relative position of the current page in an analog manner, while the size of the icon indicates the relative size of the page in relation to the size of the whole document. With an increasing size of the item collection, such a representation is less useful.

The prior art has already recognized the problem of managing long lists.

U.S. Pat. No. 5,959,626 discloses a graphical user interface where items are presented next to each other as well as below each other. In fact, a list is divided into a small number of list parts, and the list parts are presented next to each other. Of each list part, only a small number of consecutive items fits on the screen. When scrolling, all lists are scrolling at the same time. This method will only offer a limited reduction of scroll time and scroll actions. For instance, if the width of the items corresponds to one-fifth of the width of the screen, it is possible to divide the list into five list-parts and to place these five list-parts next to each other on the screen; compared to a situation where only one list is presented on screen, the scroll time and scroll actions are only reduced by a factor of five.

U.S. Pat. No. 6,239,803 discloses a method for presenting a list of items, wherein the manner of presentation depends on the relative length of the list. In case the list contains between 3 and 5 pages, the presentation includes UP and DOWN buttons, for jumping up and down one page, respectively. In case the list is longer than 5 pages, the presentation includes BINARY UP and BINARY DOWN buttons as well as a linear scroll bar. With the actuation of a binary up/down button, the presentation is limited to an upper half or lower half of a current list section. The publication mentions an example of a list having 1792 items, and a display fitting pages of 14 items, in which case the 128 pages can be accessed by 7 actions of the binary up/down buttons. With the linear scroll bar, the user is allowed to travel the list in a linear manner.

The methods proposed in the prior art may be helpful in cases where the number of pages is “medium” large. However, in case the number of pages is large, the scroll time is still quite long and the scroll actions are still quite numerous. In most prior-art systems, browsing through a list of such length may take a number of hours, even when assuming a step time as short as less than a second per scrolling step.

It is an object of the present invention to provide a method for presenting items in a list, and a method for navigating through such a list, which offers a substantial reduction of scroll time and scroll actions in the case of long lists. For example, the present invention may be very useful for scrolling lists with thousands of items, or even of the order of more than 1,000,000 items, although the present invention can also be used with shorter lists.

According to an important aspect of the present invention, the user is offered the possibility of selecting step length. For instance, in the case of a list having 1,000,000 items, a step length of 100,000 items will allow the user to step from start to end within 10 steps. When the user approaches the vicinity of a target item, he may suitably reduce the step length.

According to a preferred aspect of the present invention, a plurality of step bars is displayed on screen, each bar being associated with step control buttons, steps in different bars having different lengths. An indicator along the length of each bar may represent the position of the current display measured along each bar. The user may browse up and down through the list by taking steps along a selected one of said bars.

According to a further preferred aspect of the present invention, the user may even directly go to a target location by placing each indicator at a certain location along the length of the corresponding bar. By way of example, in the case of a list having 1,000,000 items, 10 items fitting one page on screen, a possible embodiment features five step bars. A first step bar may allow steps of 1 page (10 items) up/down, a second step bar may allow steps of 10 pages (100 items) up/down, a third step bar may allow steps of 100 pages (1000 items) up/down, a fourth step bar may allow steps of 1000 pages (10,000 items) up/down, and a fifth step bar may allow steps of 10,000 pages (100,000 items) up/down. Then, by suitably placing only as few as five indicators along the length of the corresponding five bars, the user may access any item in a very fast manner.

These and other aspects, features and advantages of the present invention will be further explained by the following description of a preferred embodiment of the method according to the present invention with reference to the drawings, in which the same reference numerals indicate identical or similar parts, and in which:

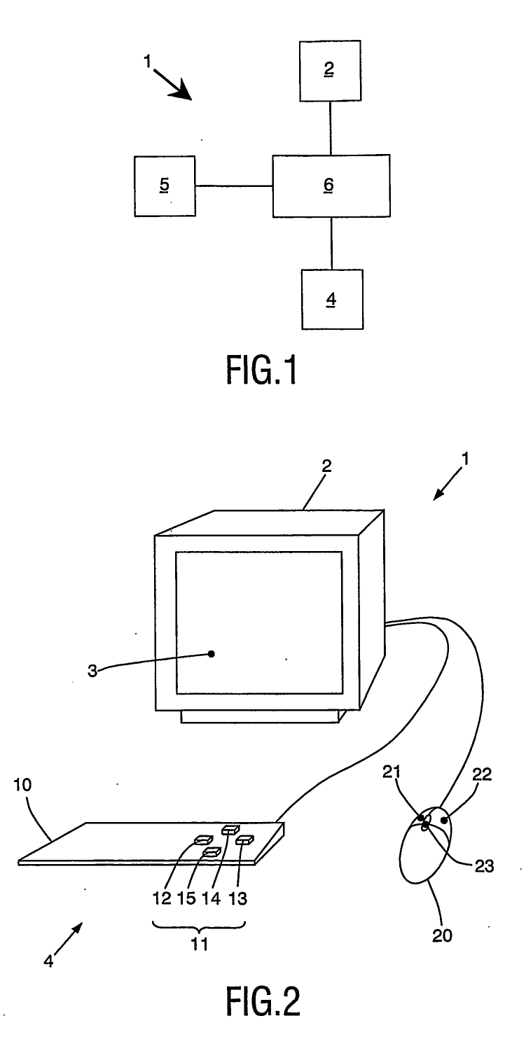

FIG. 1 is a block diagram schematically illustrating a user appliance;

FIG. 2 is a schematical perspective view of an exemple of an embodiment of a computer system;

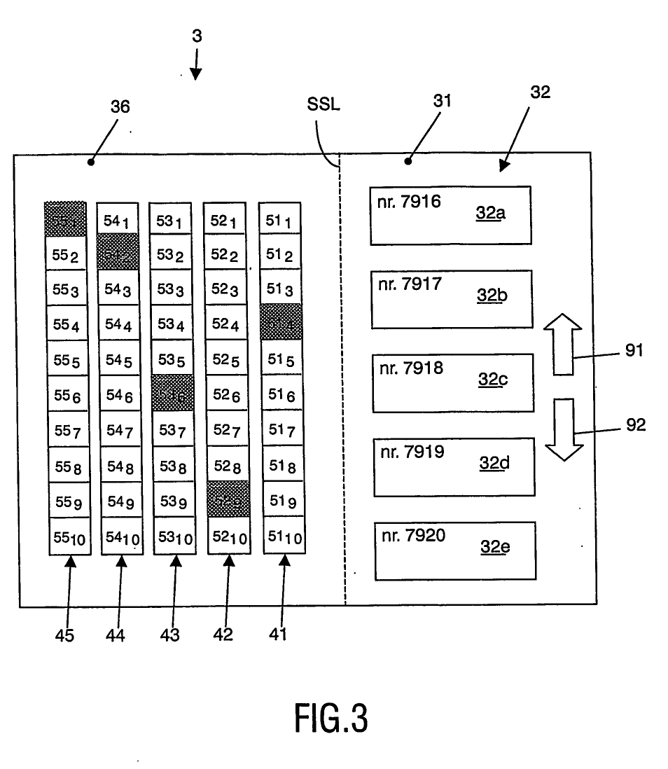

FIG. 3 is a schematical front view of a display screen; and

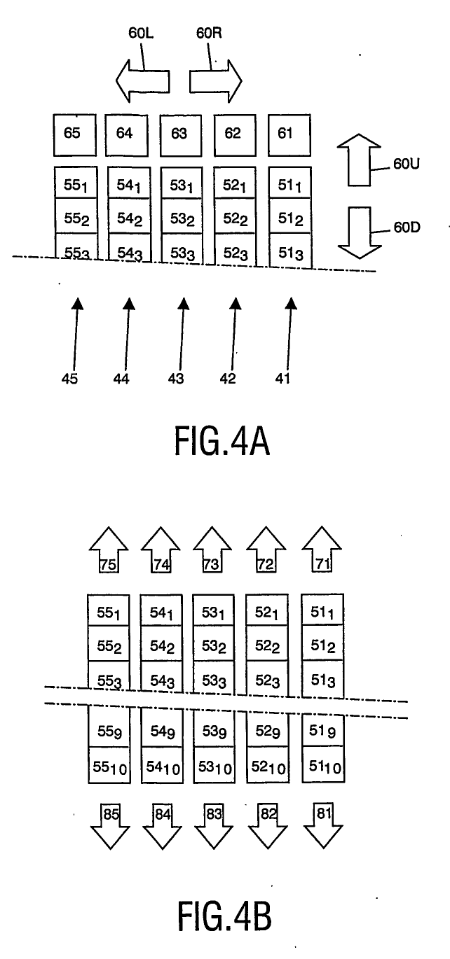

FIGS. 4A-B illustrate examples of browse control tools.

FIG. 1 is a block diagram schematically illustrating a user appliance 1, comprising a display device 2, user input means 4, an entity storing means (memory) 5, and a central processing unit (CPU) 6. In the following description, the present invention will be more specifically explained for a case where the user appliance 1 is a computer system, but it should be clear that the present invention is not restricted to computer systems but can also be applied in, for instance, a mobile telephone.

FIG. 2 is a schematical perspective view of an exemple of an embodiment of a computer system 1. As illustrated, the display device 2 can be implemented for instance as a monitor, such as a conventional CRT, but the display device 2 may also be implemented in any other suitable way. Since display devices are generally known, since the present invention is not concerned with the functioning of display devices, and since the present invention can be practised using prior-art display devices, a further description of the design and functioning of the display device 2 is omitted here. Suffice it to say that the display device 2 has a screen 3 for displaying images.

As illustrated, the user input means 4 may be implemented as a separate hardware device, such as for instance a keyboard 10 or a pointer control device (mouse) 20. Since keyboards and mouses are generally known, since the present invention is not concerned with the functioning of a user input means, and since the present invention can be practised using prior-art user input means, a further description of the design and functioning of the user input means 4 is omitted here. Suffice it to say that a keyboard 10 is generally equipped with cursor control keys 11, especially a LEFT key 12, a RIGHT key 13, an UP key 14, and a DOWN key 15. With respect to a mouse 20, suffice it to say that it is generally equipped with a left-hand mouse key (LMK) 21, a right-hand mouse key (RMK) 22, and a scroll wheel 23.

However, it is to be noted that the present invention is not restricted to user input means of the above-described types. For instance, as should be clear to a person skilled in the art, the display device 2 may also comprise a touch-sensitive screen 3, in which case the user input means 4 is incorporated in the screen. Also, the user input means 4 may comprise a microphone (not shown) and a speech recognition facility, typically implemented as a software program of the CPU 6, in which case the user may give commands to the CPU 6 by spoken words.

Furthermore, in the case of a mouse 20, the CPU 6 may be designed to process signals from the LMK 21, the RMK 22, and the scroll wheel 23 in a way identical to or similar to the processing of signals from cursor control keys 11. However, as should be clear to a person skilled in the art, the system 1 may also comprise a graphical user interface facility, wherein button fields are imaged on the screen 3, wherein a graphical pointer is manipulated by a mouse ball (not shown), and wherein a command is given to the CPU by actuating one of the mouse keys when the pointer is aligned with a selected button field. Since this technology is well known, it will not be explained here in further detail. Hereinafter, when discussing an embodiment with such a graphical interface, this way of giving user commands to the CPU 6 will simply be indicated by the phrase “clicking a button”.

The memory 5 contains a collection of entities, the number of entities in the memory 5 being generally indicated as Ne. In general, it will be assumed that Ne is extremely large; by way of example, for the sake of discussion, Ne will be taken to be equal to 1,000,000. Furthermore, by way of example, it will be assumed that the entities are pictures, such as photos taken by a digital camera, but it should be clear from the introductory part that this example is in no way meant to limit the scope of the invention.

FIG. 3 is a schematical front view of a display screen 3. Part of the screen 3 is used for presenting items representing entities. This screen part is indicated as item presentation screen section (IPSS) 31. The items will generally be indicated by reference numeral 32; individual items on screen will be distinguished by adding letters a, b, c, etc to the numeral 32.

In the context of the present invention, the content of the items is not important. Each item may be an image, a text portion, or a combination of both. Items themselves may be stored in the memory 5; however, items may also be derived from the entities stored in the memory. For instance, in the case of photos, items may be identical to entities, i.e. each photo may be displayed in fall resolution, but it is also possible that the items comprise a smaller picture at reduced resolution, derived by the CPU 6 from the full resolution photo stored in the memory 5.

Relevant in the context of the present invention is the number of items displayed in the IPSS 31. Generally, this number will be indicated as Ni/p. In the example shown, this number is equal to 5. It is noted that, in the example shown, the items 32 are shown as having a substantially rectangular shape and as being displayed below each other, i.e. in one row. Although in many instances this will be the most appropriate way of presentation, this is by no means the only way. Alternatively, the items may be displayed next to each other. Or, in the case of smaller items, for instance of square shape, items may be displayed in a matrix of horizontal rows and vertical columns. In any case, the items displayed on screen constitute a partial collection taken from the original collection of items; this partial collection will be indicated by the phrase “page”. The number of items in one page will also be indicated by the phrase “page size” Sp; evidently, Sp=Ni/p.

The number of pages associated with the collection of entities in the memory is generally indicated as Np; in the present example, Np=200,000.

The screen 3 further comprises a browse control screen section (BCSS) 36, in which a number of browse control tools 40 are displayed. In the example shown, the BCSS 36 is shown next to the IPSS 31; although this is considered to be convenient, the present invention is not limited to such a configuration.

The browse control tools 40 comprise a first set 41 of page indicators generally indicated by reference numeral 51; individual page indicators will be distinguished by addition of an index m. This first set of indicators will also be indicated as first level volume 41. The number of page indicators 51 in the first level volume 41 will generally be indicated as Np/v, so m can have a value between 1 and Np/v; in this example, Np/v=10. Although this is a convenient number, the present invention is not limited to such a configuration. In the example shown, the page indicators 51 are shown as being displayed below each other, so that the first level volume 41 has the shape of a vertical bar; for this reason, the first level volume 41 will also be referred to as page indicator bar. Although this is considered to be convenient, the present invention is not limited to such a configuration.

Similarly, the browse control tools 40 comprise a second set 42 of page indicators 52, a third set 43 of page indicators 53, etc. The second set 42 will also be indicated as second level volume, the third set 43 will also be indicated as third level volume, etc. The total number of volumes depends, inter alia, on the number Np of pages, as will be explained later. In the present example of FIG. 3, only five volumes 41, 42, 43, 44, 45 are shown. Preferably, and as illustrated, the number of page indicators 51-55 in the volumes 41-45, respectively, is always the same (10 in this case), although this is not essential and the present invention is not limited to such a design.

In the original collection of items, the items are arranged in a certain order, and each item can be considered as having a unique number corresponding to the ranking in said order. For instance, photos may be arranged in a chronological order, names may be arranged alphabetically, etc. In the following description, individual items 32 will be indicated by their ranking j as item 32(j), j being an integer between 1 and Ne. Then the first page will contain items 1 to Sp, the second page will contain items (Sp+1) to 2Sp, etc. In general, the x-th page will contain items ((x−1)·Sp+1) to x·Sp.

The page indicators 51, 52, 53, etc in the volumes 41, 42, 43 etc indicate to the user which page he is looking at. Each page indicator has two operative states, indicated here as ON and OFF, respectively. In each volume, only one indicator can be ON, the other indicators of such a volume are OFF. In the first level volume 41, an m-th page indicator 51ₘ (m being an integer between 1 and Np/v) being ON indicates an m-th page within the first level volume 41. Thus, with the first level volume 41, it is possible to indicate Np/v pages.

For indicating further pages, the second level volume 42 is used. In the second level volume 42, an n-th page indicator 52ₙ (n being an integer between 1 and Np/v) indicates an offset of (n−1)·Np/v pages. Thus, with the combination of first level volume 41 and second level volume 42, it is possible to indicate (Np/v)² pages.

Similarly, for indicating still further pages, the third level volume 43 is used, etc. As should now be clear to a person skilled in the art, with a combination of P volumes, P being an integer, it is possible to indicate (Np/v)^{P} pages, assuming that each volume contains the same number of indicators. If these numbers are different, a person skilled in the art will know how to calculate the number of pages that can be indicated.

In our example of 1,000,000 items, 5 items per page, 10 indicators per volume: 6 volumes are needed; it is noted that only two indicators are needed in the sixth volume.

According to one aspect of the present invention, the page indicators of the different level volumes offer the user an easy indication of the relative location within the collection of the current page displayed on screen. As will be clear to a person skilled in the art, the distinction between ON-state and OFF-state can be made by difference in color, difference in darkness, difference in shape, the presence or absence of an icon, etc. In the example of FIG. 3, OFF indicators are shown as white squares while ON indicators are shown as black squares.

In the example of FIG. 3, the fourth page indicator 51₄ of the first level volume 41 is ON, the ninth page indicator 52₉ of the second level volume 42 is ON, the sixth page indicator 53₆ of the third level volume 43 is ON, and the second page indicator 54₂ of the fourth level volume 44 is ON, indicating that the page currently displayed on screen is number
(2−1)·(Np/v)³+(6−1)·(Np/v)²+(9−1)·(Np/v)¹+4=1584,
so the items on screen are items 7916-7920.

According to another aspect of the present invention, the user is offered an easy browsing facility. By means of user input means 4, the user can give UP or DOWN commands to the CPU 6 if he wishes to step to another page. In this respect, it is noted that the UP and DOWN perception, for the user, corresponds to the notion of increasing or decreasing the number of the items, but also corresponds to the visual display. Giving an UP command may therefore correspond to a step towards a higher item number, but in cases where items are displayed from top to bottom, as usual, and as illustrated, an UP command may also correspond to a step towards the beginning of the collection (item number 1). Also, if the volumes 41, 42, etc are displayed as a horizontal bar, browsing may alternatively be done by RIGHT and LEFT keys. In the present example, however, stepping through pages (browsing) is done by giving UP/DOWN commands.

According to an important aspect of the present invention, browsing is performed in one of the indicator volumes or indicator bars 41-45, browsing involving a step of selecting another page indicator in such an indicator volume or indicator bar. For instance, a user may browse in the first indicator bar 41. Starting from the situation in FIG. 3, where the fourth page indicator 51₄ of the first indicator bar 41 is ON, the user may give a BROWSE UPWARDS command to the CPU 6 or a BROWSE DOWNWARDS command to the CPU 6. In response to receiving the BROWSE UPWARDS command, the CPU 6 will switch the fourth page indicator 51₄ OFF and will switch the third page indicator 51₃ ON; the user perceives this as an indicator moving upwards on the first indicator bar 41, for which reason the action of the CPU 6 will also be termed “displacing the indicator”. Furthermore, the CPU 6 will display page 1583 on IPSS 31, i.e. items 7911 to 7915. In response to receiving the BROWSE DOWNWARDS command, the CPU 6 will switch the fourth page indicator 51₄ OFF and will switch the fifth page indicator 51₅ ON (i.e. displacing the indicator downwards), and the CPU 6 will display page 1585 on IPSS 31, i.e. items 7921 to 7925.

The user may also browse in the second indicator bar 42. Starting from the situation in FIG. 3, where the ninth page indicator 52₉ of the second indicator bar 42 is ON, the user may give a BROWSE UPWARDS command to the CPU 6 or a BROWSE DOWNWARDS command to the CPU 6. In response to receiving the BROWSE UPWARDS command, the CPU 6 will switch the ninth page indicator 52₉ OFF and will switch the eighth page indicator 52₈ ON, and the CPU 6 will display page 1574 on IPSS 31, i.e. items 7866 to 7870. In response to receiving the BROWSE DOWNWARDS command, the CPU 6 will switch the ninth page indicator 52₉ OFF and will switch the tenth page indicator 52₁₀ ON, and the CPU 6 will display page 1594 on IPSS 31, i.e. items 7966 to 7970.

Likewise, in response to a step UPWARDS or DOWNWARDS in the third indicator bar 43, page 1484 or page 1684, respectively, will be displayed. In response to a step UPWARDS or DOWNWARDS in the fourth indicator bar 44, page 584 or page 2584, respectively, will be displayed, and so forth.

Thus, browsing in accordance with the present invention involves the step of giving an UP or DOWN command to the CPU 6 as well as indicating to the CPU 6 a volume in which browsing takes place. The invention provides several possibilities for conveniently inputting such commands to the CPU 6, as will be explained with reference to FIGS. 4A-4B.

FIG. 4A illustrates a first exemple of an embodiment in which the browse control tools 40 displayed in BCSS 36 comprise a series of bar indicators 61, 62, . . . 65 associated with page indicator bars 41, 42, . . . 45, respectively. Similarly to the page indicators, each bar indicator can be displayed in either one of two states, i.e. an ON state or an OFF state. At any moment, only one bar indicator is ON, while all others are OFF. The one bar indicator in the ON state indicates that the corresponding page indicator bar is ACTIVE.

Browsing takes place in the ACTIVE volume, i.e. the CPU 6 will process an UP or DOWN command in respect of the ACTIVE page indicator bar. For instance, if the second page indicator bar 42 is ACTIVE, indicated by the second bar indicator 62 being ON, and the user gives an UP/DOWN command to the CPU 6, the CPU 6 will displace the indicator of the second page indicator bar 42 upwards/downwards and will display page 1574 or 1594 (in the example of FIG. 3). In general, if the x-th page indicator bar is ACTIVE, indicated by the x-th bar indicator being ON, and the user gives an UP/DOWN command to the CPU 6, the CPU 6 will displace the indicator of the x-th page indicator bar upwards/downwards and will display the new page now indicated by the page indicators.

Entering an UP/DOWN command may be done by pressing UP key 14 or DOWN key 15 of the keyboard 10. It is also possible that entering an UP/DOWN command may be done by suitably manipulating a scroll wheel of the mouse 20, or by suitably displacing the mouse 20 to the front or to the back. It is also possible that the CPU 6 displays an UP icon 60U and a DOWN icon 60D, and that entering an UP/DOWN command may be done by clicking one of these icons or, in the case of a touch screen, touching one of these icons. However, the present invention is not limited to the above examples: other methods for entering an UP/DOWN command are possible, too.

The user may also input commands for indicating a volume for browsing. This may conveniently be done by inputting a LEFT command or a RIGHT command to the CPU 6. For instance, with reference to FIG. 4A, if the second page indicator bar 42 is ACTIVE, indicated by the second bar indicator 62 being ON, and the user gives a LEFT/RIGHT command to the CPU 6, the CPU 6 will switch the second bar indicator 62 OFF and will switch the third/first bar indicator 63/61 ON (also referred to as displacing the active bar indicator to the left or to the right), indicating that the third/first bar 43/41 is now ACTIVE. After that, by entering UP/DOWN commands, the user may browse through the newly active volume 43/41.

Entering a LEFT/RIGHT command may be done by pressing LEFT key 12 or RIGHT key 13 of the keyboard 10. It is also possible that entering a LEFT/RIGHT command may be done by suitably manipulating a scroll wheel of the mouse 20, or by suitably displacing the mouse 20 to the left or to the right. It is also possible that the CPU 6 displays a LEFT icon 60L and a RIGHT icon 60R, and that entering a LEFT/RIGHT command may be done by clicking one of these icons or, in the case of a touch screen, touching one of these icons. However, the present invention is not limited to the above examples: other methods for entering a LEFT/RIGHT command are possible, too.

FIG. 4B illustrates a second exemple of an embodiment in which the browse control tools 40 displayed in BCSS 36 comprise a series of UP icons 71, 72, . . . 75 suitably displayed above the page indicator bars 41, 42, . . . 45, respectively, as well as a series of DOWN icons 81, 82, . . . 85 suitably displayed below the page indicator bars 41, 42, . . . 45, respectively. The user may click (or, in the case of a touch screen: touch) any of these icons, which will be interpreted by the CPU 6 as a simultaneous input of UP/DOWN command as well as volume selection. For instance, if the user clicks the second UP icon 72, the CPU 6 will displace the indicator of the second page indicator bar 42 upwards and will display page 1574 (in the example of FIG. 3).

The CPU 6 may be programmed to display the clicked icon in a specific ON state, indicating that the corresponding volume is ACTIVE; further browsing in this volume may then be done by using, for instance, UP/DOWN keys 14 and 15, and changing the active volume may be done by using, for instance, LEFT/RIGHT keys 12 and 13, as described above with reference to the embodiment of FIG. 3A.

It may seem that the user can only step through a page indicator bar from one end to the other, so that the number of browsing steps possible in one volume is equal to the size of such a volume, i.e. the number Np/v of page indicators in the indicator bar. Preferably, however, the CPU 6 is capable of allowing browsing in any of the volumes from the beginning of the list to the end, by automatically making a browsing step in the next higher level volume, as will be explained hereinafter.

Starting from the situation in FIG. 3, where the ninth page indicator 52₉ of the second indicator bar 42 is ON, the user may give a DOWN command to the CPU 6; in response, as already explained, the CPU 6 will switch OFF the ninth page indicator 52₉ and will switch ON the tenth page indicator 52₁₀, and the CPU 6 will display page 1594 on IPSS 31, i.e. items 7966 to 7970. The user has now reached the lower end of the second indicator bar 42; nevertheless, the user may give a further DOWN command to the CPU 6. In response, the CPU 6 will displace the page indicator to the opposite end of the second indicator bar 42 (i.e. switch OFF the tenth page indicator 52₁₀ and switch ON the first page indicator 52₁) and will also displace downwards the page indicator of the next indicator bar 43 of higher level (i.e. switch OFF the sixth page indicator 53₆ of the third indicator bar 43 and switch ON the seventh page indicator 53₇ of the third indicator bar 43), while also displaying page 1604 on IPSS 31, i.e. items 8016 to 8020.

In effect, the user may thus continue browsing downwards in the second volume 42 till he reaches the end of the list.

It should be clear from the above that browsing involves taking steps in the list (for instance, browsing in the second volume 42 involves steps of 50 items at a time), and that the user is allowed to change the size of the steps by selecting another volume (for instance, making the third volume ACTIVE is equivalent to setting the browsing step size equal to 500 items, in this example).

It is also possible that the system 1 allows direct access to a specific page selected by the user, by allowing the user to directly amend the setting of the page indicators 51, 52, . . . 55. For instance, the page indicators 51, 52, . . . 55 may be provided with corresponding buttons, in which case the user may set a specific page indicator to its ON state by clicking the corresponding button. In the case of a touch screen, the user may set a specific page indicator to its ON state by touching the screen at the corresponding location. Then, in the example of FIG. 3, the user may access any selected page by only five mouse clicks (or screen touches).

The invention has been explained hereinbefore with reference to an example (FIG. 3) where the browse control tools 40 in BCSS 36 comprise five volumes of ten page indicators each. This is, however, just an example; the browse control tools 40 in BCSS 36 may comprise more or less than five volumes, and the number of page indicators in each volume may be more or less than ten. Furthermore, it is not necessary that all volumes have the same number of page indicators.

In one possible embodiment, the user may select the configuration of parameters Sp (size of page), Nv (number of volumes, i.e. indicator bars), and Np/v (number of page indicators per volume). There are, of course, limits to the selection freedom for the user. The length of an indicator bar is limited by the corresponding size (height) of the screen 3. The number of page indicators per volume Np/v is limited by the minimum size of each page indicator in combination with the length of an indicator bar. The number of volumes Nv is limited by the minimum size of each page indicator in combination with the corresponding size (width) of the BCSS 36 of the screen 3. Within these limits, the user may choose to have NP/v as large as possible, but he may also choose to have Nv as large as possible, which offers the advantage of a large choice in step lengths for browsing.

For instance, in the above example, the number of page indicators per volume Np/v was selected to be equal to ten, which is convenient in relation to the decade system of counting. In this example, the number of volumes needed would be six, but, as mentioned, only two page indicators of the sixth indicator bar would be used in this example. If, for instance, the number of page indicators per volume Np/v was selected to be equal to four, nine volumes would be needed. Although possible within the scope of the present invention, it is hardly useful to select the number of page indicators per volume Np/v to be smaller than four. On the other hand, it is hardly useful to select the number of volumes Nv to be smaller than five, because this would involve a large value for Np/v: in the above example, if Np/v would be equal to 20, the number of volumes needed would still be 5.

In another possible embodiment, the CPU 6 may be designed to automatically set the parameters Sp, Nv, and Np/v at suitable values, appropriate in relation to the size of IPSS 31 and BCSS 36, and the size of the page indicators. For instance, the CPU 6 may take the following steps.

In one step, the size of the IPSS 31 is determined, the size of the items 32 is determined, and the number of items per page Ni/p=Sp is calculated as the number of items fitting in the IPSS 31.

Then, the number of entities Ne in the collection is determined, and the number of pages Np is calculated as:
Np=Ne/(Ni/p).

In another step, the size is determined of that part of the BCSS 36 which is available for the indicator bars, taking into account the size of possible bar indicators 61-65 and possible UP/DOWN and/or LEFT/RIGHT icons 60. Furthermore, the size of the page indicators is determined. From these sizes, the maximum possible number of page indicators per volume NP/v_{MAX} is calculated, and the maximum possible number of volumes Nv_{MAX} is calculated.

Then, the CPU 6 selects a combination of Np/v and Nv which meets the following conditions:

1) Np/v to the power of Nv is larger than Np;

2) Nv_{MIN}≦Nv_{MAX}, Nv_{MIN} being a minimum value, preferably being equal to 4;

3) NP/v_{MIN}≦Np/v≦Np/V_{MAX}, Nv_{MIN} being a minimum value, preferably being equal to 4.

In a preferred embodiment, the CPU 6 is designed to select Nv to be as close to Nv_{MAX} as possible.

Thus, the present invention provides a method and an apparatus for presenting a long list of items. Specifically, the present invention provides an apparatus for displaying one page of items and a set of browse control tools 40 which include page indicators, the apparatus having user input means 4. The apparatus is designed to display a new page in response to user input commands. The apparatus is further designed to set a step length, i.e. the distance (number of items) between current page and new page, in response to user input commands. The browse control tools 40 comprise a plurality of hierarchic volumes 41, 42, 45, each volume comprising a plurality of page indicators 51, 52, . . . 45.

It should be clear to a person skilled in the art that the present invention is not limited to the exemples of embodiments discussed above but that various variations and modifications are possible within the protective scope of the invention as defined in the appending claims.

The invention has been explained hereinbefore for embodiments in which browsing involves steps of an integral number of pages. However, it is also possible that the system 1 allows steps having a size smaller than the size of one page, for instance steps of one item at a time. This will be termed scrolling. For this facility, the system may comprise scrolling command tools, for instance UP/DOWN icons 91/92 displayed in the IPSS 31 (see FIG. 3). Starting from the situation illustrated in FIG. 3, if the user clicks the UP/DOWN icon 91/92, the CPU 6 will display the items 7915 to 7919 or the items 7917 to 7921, respectively. If the user has scrolled a number of items equal to the page size Sp=Ni/p, the CPU 6 will displace the indicator in the first indicator bar 41 accordingly.

In the example as described above, each page indicator 51, 52, . . . 55 can only take discrete steps, corresponding to a display offset of an integral number of times (Np/v) to the zero, first, second, third, etc. power. However, it is also possible that each page indicator 51, 52, . . . 55 is continuously displaceable along the corresponding bar, allowing offset to take intermediate values.

It is also possible that the system 1 allows the user to displace a screen separator line SSL in order to change the relative sizes of IPSS 31 and BCSS 36.

In the example of FIG. 3, the page indicator bars are arranged with decreasing step size from left to right; however, this order may be the opposite.

Furthermore, although the present invention has been explained on the basis of an exemple of a system having customary user input means 4 and a customary mouse device 20, it is also possible that the user input means 4 comprises special hardware such as a device having an UP/DOWN scroll wheel as well as a LEFT/RIGHT scroll wheel.

1. A method for presenting a long list of items, comprising the steps of:
displaying one page containing a predetermined number (Ni/p) of items in one section (31) of a display screen (3);
receiving a step size selection command from a user;
setting a step size in response to the step size selection command received;
receiving a step command (UP/DOWN) from a user;
displaying a new page of items, wherein the distance between the new page and the previously displayed page is equal to said step size.

2. A method as claimed in claim 1, further comprising the step of displaying a set of browse control tools (40) in a second section (36) of said display screen (3);
wherein said browse control tools (40) comprise a plurality of hierarchic indicator volumes (41, 42, . . . ) each comprising a plurality of page indicators (51, 52, . . . ).

3. A method as claimed in claim 2, wherein one of said indicator volumes (41, 42, . . . ) is made ACTIVE in response to a step size selection command, and wherein the step size (SS) corresponds to one page size (Sp=Ni/p items) if the first indicator volume (41) is ACTIVE, and wherein, if the n-th indicator volume is ACTIVE, the step size corresponds to the following formula
$$SS = ( Ni \text{/} p ) \cdot {\prod }_{i = 1}^{n - 1} ( Np \text{/} v ( i ) ) items$$
wherein Np/v(i) indicates the number of page indicators in the i-th indicator volume.

4. A method as claimed in claim 3, wherein one of said page indicators in the ACTIVE volume is switched to an ON state in response to a step command (UP/DOWN).

5. A method as claimed in claim 4, wherein, in response to a step command (UP/DOWN), a currently ON page indicator within said ACTIVE volume is switched to an OFF state while a page indicator adjacent said currently ON page indicator is switched to said ON state.

6. A method as claimed in claim 4, wherein, in response to a step command (UP/DOWN), if a currently ON page indicator within said ACTIVE volume is located at the end of the volume, said currently ON page indicator is switched to an OFF state while a page indicator at the opposite end of the ACTIVE volume is switched to said ON state, while also a currently ON page indicator within a second volume one hierarchic level higher than said ACTIVE volume is switched to an OFF state while a page indicator adjacent said currently ON page indicator within said second volume is switched to an ON state.

7. A system (1) for presenting a long list if items, comprising a display device (2) having a screen (3), user input means (4), and a CPU (6), the system being designed to perform the method according to any one of claims 1 to 6.

8. A system as claimed in claim 7, wherein said user input means comprise a keyboard (10) comprising a LEFT key (12) and a RIGHT key (13), and wherein said CPU (6) is designed to interpret an actuation of said LEFT key (12) or said RIGHT key (13) as a step size selection command.

9. A system as claimed in claim 7, wherein said user input means comprise a mouse device (20) comprising a LEFT mouse key (21) and a RIGHT mouse key (22), and wherein said CPU (6) is designed to interpret an actuation of said LEFT mouse key (21) or said RIGHT mouse key (22) as a step size selection command.

10. A system as claimed in claim 7, designed to display a LEFT command icon (60L) and a RIGHT command icon (60R) on said screen (3), and wherein said CPU (6) is designed to interpret a click action at said LEFT command icon (60L) or said RIGHT command icon (60R) as a step size selection command.

11. A system as claimed in claim 7, designed to display a LEFT command icon (60L) and a RIGHT command icon (60R) on said screen (3), wherein said screen (3) is a touch screen, and wherein said CPU (6) is designed to interpret a touch action at said LEFT command icon (60L) or said RIGHT command icon (60R) as a step size selection command.

12. A system as claimed in claim 7, wherein said user input means comprise a keyboard (10) comprising an UP key (14) and a DOWN key (15), and wherein said CPU (6) is designed to interpret an actuation of said UP key (14) or said DOWN key (15) as a step command (UP/DOWN).

13. A system as claimed in claim 7, wherein said user input means comprise a mouse device (20) comprising a scroll wheel (23), and wherein said CPU (6) is designed to interpret an actuation of said scroll wheel (23) as a step command (UP/DOWN).

14. A system as claimed in claim 7, designed to display an UP command icon (60U) and a DOWN command icon (60D) on said screen (3), and wherein said CPU (6) is designed to interpret a click action at said UP command icon (60U) or said DOWN command icon (60D) as a step command (UP/DOWN).

15. A system as claimed in claim 7, designed to display an UP command icon (60U) and a DOWN command icon (60D) on said screen (3), wherein said screen (3) is a touch screen, and wherein said CPU (6) is designed to interpret a touch action at said UP command icon (60U) or said DOWN command icon (60D) as a step command (UP/DOWN).

16. A system as claimed in claim 7, designed to display a plurality of UP command icons (71, 72, . . . 75) associated with corresponding page indicator volumes (41, 42, . . . 45) and a plurality of DOWN command icons (81, 82, . . . 85) associated with corresponding page indicator volumes (41, 42, . . . 45), and wherein said CPU (6) is designed to interpret a click action or touch action at one of said UP or DOWN command icons (71, 72, . . . 75; 81, 82, . . . 85) as a combined step size selection command and step command (UP/DOWN).

17. A system as claimed in any one of claims 7 to 16, designed to display a plurality of bar indicators (61, 62, . . . 65) associated with corresponding page indicator volumes (41, 42, . . . 45), wherein said CPU (6) is designed to display in an ON state the one bar indicator corresponding to the ACTIVE volume.

18. A system as claimed in claim 17, wherein said CPU (6) is designed to interpret a click action or touch action at one of said bar indicators (61, 62, . . . 65) as a step size selection command.

19. A system as claimed in any one of claims 7 to 18, wherein said CPU (6) is designed to interpret a click action or touch action at one of said page indicators as a combined step size selection command and step command (UP/DOWN).

20. A system as claimed in any one of claims 7 to 18, wherein said CPU (6) is designed to calculate an appropriate number of volumes (Nv) and an appropriate number of page indicators (Ni/p) in each volume, taking into account size of screen, size of item, size of page indicator.
